(19) United States
(12) Patent Application Publication
(10) Pub. No.: US 2013/0173598 A1
(43) Pub. Date: Jul. 4, 2013

(54) Method and Apparatus for Automated Pattern Analysis to Identify Location Information in Cellular Telephone Records

(71) Applicant: Victor Nguyen, San Diego, CA (US)

(72) Inventor: Victor Nguyen, San Diego, CA (US)

(73) Assignee: Victor Nguyen, San Diego, CA (US)

(21) Appl. No.: 13/531,553

(22) Filed: Jun. 24, 2012

Related U.S. Application Data
(60) Provisional application No. 61/582,485, filed on Jan. 2, 2012.

(51) Int. Cl. G06F 17/30

(52) U.S. Cl. 707/722; 707/E17.014

(57) ABSTRACT

A method and apparatus for analyzing cellular telephone records is provided. The analysis applies a statistics-based approach to determine patterns in cellular activity and identify pertinent location information in the cellular telephone records.

### CROSS-REFERENCE TO RELATED APPLICATIONS

U.S. patent application No. 61/582,485, filed January 2012, by Nguyen.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO SEQUENCE LISTING, A TABLE, OR A COMPUTER PROGRAM LISTING COMPACT DISC APPENDIX (IF APPLICABLE)

A computer program listing appendix submitted on one compact disc, incorporated herein by reference. The compact disc contains one file, named apparatus.txt.

### BACKGROUND OF THE INVENTION

Cellular telephone records contain location information, such as cell sites utilized by the cellular telephone during such activity as a telephone call, text messaging, or internet usage. These cell sites are at known locations, and provide one method of determining the general location of the cellular telephone.

Cellular telephone records have been analyzed in the past in order to identify cell sites, or other location information, used at the beginning and end of unusually long periods of inactivity. These analyses have been performed within the law enforcement community in an attempt to determine patterns in the data and obtain information on where the cellular telephone might be located. In the past, the determination of what constituted an unusually long period of inactivity was an estimate made by the individual reviewing the cellular telephone records. In addition, the process of reviewing the records was a manual one.

As such, there is a need for an automated system of determining unusually long periods of inactivity and then applying that analysis throughout the cellular telephone records.

### BRIEF SUMMARY OF THE INVENTION

The invention is an automated pattern analysis technique for cellular telephone records using a statistics-based process in order to identify location information at the beginning and end of unusually long periods of inactivity.

### BRIEF DESCRIPTION OF THE SEVERAL VIEWS OF THE DRAWING

FIG. 1 is a flowchart showing the steps in the automated pattern analysis technique.

### DETAILED DESCRIPTION OF THE INVENTION

This invention is an automated pattern analysis technique for cellular telephone records using statistics-based formulas in order to identify cellular telephone location information at the beginning and end of unusually long periods of inactivity. The pattern analysis technique calculates the time between cellular telephone activity, and identifies those time differences which are more than one standard deviation above the average time difference of all cellular telephone activity. In one embodiment, the invention is incorporated into the spreadsheet program Microsoft Excel using Visual Basic for Applications.

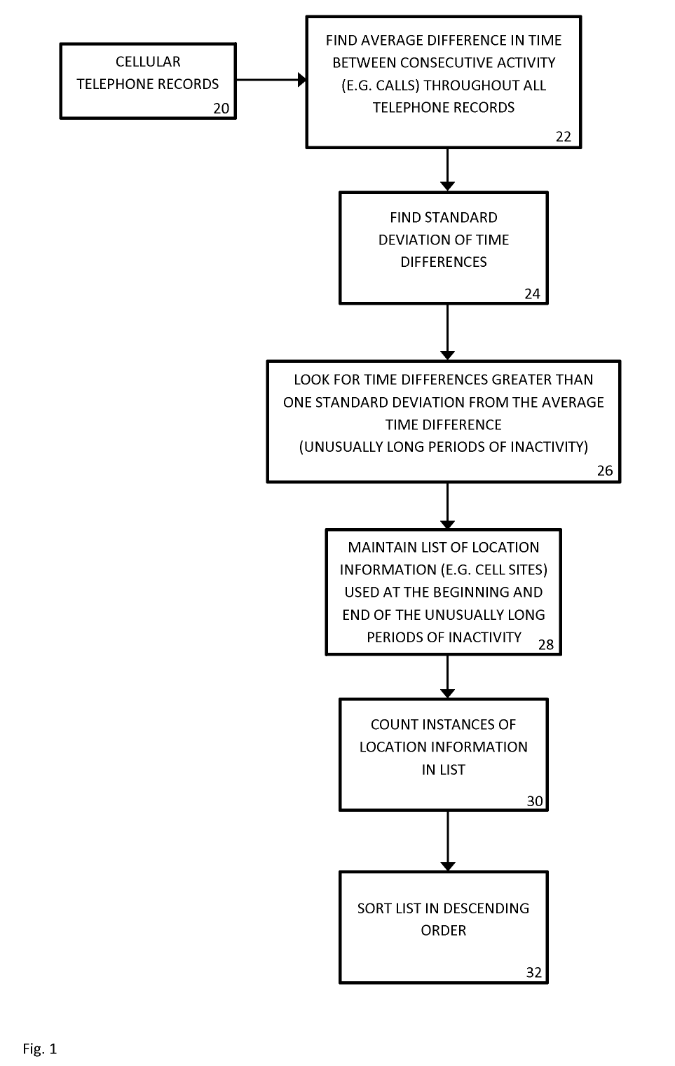

Referring to the flowchart shown in FIG. 1, the analysis begins with the cellular telephone records, with the activity (e.g. calls) sorted in date and time order 20. The difference in time between consecutive periods of activity is found, and the average of those time differences throughout the cellular telephone records is calculated 22. The standard deviation of the time difference between consecutive periods of activity throughout the cellular telephone records is calculated 24. Each difference in time between consecutive periods of activity is then compared to the average and standard deviation values 26. If the difference in time between consecutive periods of activity is larger than the sum of the average and standard deviation, then that difference in time is categorized as being an unusually long period of inactivity. The location information (e.g. cell sites) used by the cellular telephone at the beginning and end of the unusually long period of inactivity are placed in a list 28. After each difference in time between consecutive periods of activity is evaluated against the average and standard deviation, the number of instances of each cell site in the list is counted 30. The counted list is then sorted in descending order 32.

The advantages of this invention are its automation and its use of statistical analysis techniques. The automation allows a large number of cellular telephone records to be analyzed quickly and consistently. The use of statistical analysis techniques allows small but significant, as well as large and obvious, time differences between cellular telephone activity to be identified.

In a broad embodiment, the invention is a statistical-based pattern analysis technique for cellular telephone records.

There are many alternative ways that the invention can be implemented, such as by evaluating time differences between cellular telephone activity to a multiple of the average and/or standard deviation; or, by implementing the method in software separate from Microsoft Excel. As such, the invention should not be limited to the above-described embodiment.

What is claimed is:

1. A method of automated pattern analysis for cellular telephone records, comprising the steps of:
a. Scanning cellular telephone records containing location information;
b. Analyzing the cellular telephone records to identify location information at the beginning and end of unusually long period of inactivity; and
c. Counting and presenting sorted location information.

2. The method as set forth in claim 1 above, wherein the step of analyzing cellular telephone records by determining the average difference between consecutive activity in the cellular telephone records.

3. The method as set forth in claim 1 above, wherein the step of analyzing cellular telephone records by determining the standard deviation of differences in time between consecutive activity in the cellular telephone records.

4. The method as set forth in claim 1 above, wherein the step of analyzing cellular telephone records by identifying location information in which the difference in time between consecutive activity is greater than the sum of the standard deviation and average difference in time between consecutive activity throughout the cellular telephone records.

5. The method as set forth in claim 1 above, wherein the step of analyzing cellular telephone records by counting identified location information.

6. The method as set forth in claim 1 above, wherein the step of analyzing cellular telephone records by presenting a sorted list of identified location information.

7. An apparatus for automated pattern analysis of cellular telephone records, comprising:
a. Scanning cellular telephone records containing location information;
b. Analyzing the cellular telephone records to identify location information at the beginning and end of unusually long period of inactivity; and
c. Counting and presenting sorted location information.

8. The apparatus as set forth in claim 7 above, wherein the step of analyzing cellular telephone records by determining the average difference between consecutive activity in the cellular telephone records.

9. The apparatus as set forth in claim 7 above, wherein the step of analyzing cellular telephone records by determining the standard deviation of differences in time between consecutive activity in the cellular telephone records.

10. The apparatus as set forth in claim 7 above, wherein the step of analyzing cellular telephone records by identifying location information in which the difference in time between consecutive activity is greater than the sum of the standard deviation and average difference in time between consecutive activity throughout the cellular telephone records.

11. The apparatus as set forth in claim 7 above, wherein the step of analyzing cellular telephone records by counting identified location information.

12. The apparatus as set forth in claim 7 above, wherein the step of analyzing cellular telephone records by presenting a sorted list of identified location information.
